(19) United States
(12) Patent Application Publication
(10) Pub. No.: US 2009/0265989 A1
(43) Pub. Date: Oct. 29, 2009

(54) DEVICE FOR OPENING AND/OR CLOSING A PIVOTING CHASSIS PIECE

(75) Inventors: Tobias Mueller, Muenchen (DE); Anton Joehl, Bad Heilbrunn (DE); Josef Appel, Gauting (DE); Thomas Kraus, Kaufering (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: WEBASTO AG, Stockdorf (DE)

(21) Appl. No.: 11/718,187

(22) PCT Filed: Oct. 25, 2005
(86) PCT No.: PCT/DE05/01914

§ 371 Date: May 12, 2009

(30) Foreign Application Priority Data
Oct. 29, 2004 (DE) 10 2004 052 590.0

(51) Int. Cl. E05F 15/20

(52) U.S. Cl. 49/31

(57) ABSTRACT

A device for opening and/or closing a pivoting body piece (14), especially a rear hatch, of a motor vehicle (10). The device has an electric motor drive (20) which drives a motor shaft which drives the pivotable body piece (14) via a gearing (22). In order to enable the device to have a clutch-free structure, the electric motor drive (20) is provided, in accordance with the invention, with an electronic isolation means (24) which can be activated depending on a signal from a sensor means (30) which recognizes manual actuation of the pivoting body piece (14).

### BACKGROUND OF THE INVENTION

1. Field of the Invention

The invention relates to a device for opening and/or closing a pivoting body piece, especially a rear hatch of a motor vehicle, comprising an electric motor drive which drives a motor shaft which drives the pivotable body piece via a gearing

2. Description of Related Art

These devices can be used especially as a drive for the rear hatch of a so-called minivan, a so-called sport utility vehicle (SUV), a so-called station wagon or a minibus in which the rear hatch is pivotally attached to the rear roof edge of the motor vehicle. Depending on the execution of the rear hatch, it can be very heavy, so that motor-supported actuation is desirable. For this purpose, vehicle-mounted electric motors are generally used which are connected to the rear hatch via a gearing.

To drive the rear hatches of motor vehicles, electromechanical or hydraulic systems are currently used. It is desirable for these systems to be designed such that manual intervention in the actuation of the rear hatch is possible. To date, for this purpose, when using an electromechanical drive system, the connection between the rear hatch and the drive system has been separated by means of a mechanical clutch which can generally be electrically operated. The separation can take place either in the rest state of the rear hatch or also when the electromechanical drive has been activated and manual intervention takes place so that the opening or closing motion of the rear hatch is influenced. The use of a mechanical clutch is mechanically complex and disadvantageous due to the weight of the clutch.

When using a hydraulic rear hatch drive system, manual actuation of the rear hatch can be enabled by the corresponding switching of valves, an individual manual actuation of the rear hatch nevertheless generally having to apply large actuating forces.

A device of the initially named type is known from German Patent Application DE 101 24 783 A1 and is made as a drive for opening and closing the rear hatch of a motor vehicle. This device comprises an electric motor which drives a motor shaft which is connected to the rear hatch via a gearing. The rear hatch, which is provided with this drive, can also be manually opened, the motor being able to turn concomitantly with it, or a clutch being provided to interrupt the flow of force between the electric motor and the rear hatch. However, there is no means for detecting a manual intervention.

### SUMMARY OF THE INVENTION

The object of the invention is to devise a device for opening and/or closing a pivoting body part, especially the rear hatch of a motor vehicle which, compared to existing versions with a clutch, has a simplified structure and enables manual actuation with low expenditure of force.

This object is achieved in accordance with the invention by an electric motor drive being provided with an electronic isolation means which can be activated depending on a signal of a sensor means which recognizes manual actuation of the pivoting body piece.

The heart of the invention therefore involves using a drive device for a pivoting body part that is provided with sensor technology that results in the electrical motor drive being isolated upon manual intervention so that the motor shaft can turn essentially freely and none of the forces which oppose manual activation are applied to the pivoting body part by the electric motor drive. With a conventionally used electric motor, the isolation means with corresponding sensing of manual actuation de-energizes the electric motor so that the motor shaft is shifted into a free-wheeling state. Since the motor thus no longer acts as a regenerative brake, the clutch which had been used in the past for these purposes for decoupling of the pivoting body part from the electric motor drive can be omitted. A frictional moment which is imparted by the gearing, the motor shaft bearing arrangement and the like can generally be overcome with a low expenditure of force for actuation of the pivoting body part which takes place manually by an individual and for isolation of the electric motor drive.

Furthermore, position sensor engineering which is generally used in concert with an electrical motor drive means for the rear hatch or the like can also remain active in manual actuation of the rear hatch when a clutch has been omitted.

The electric motor drive is generally used to open and close the hatch, and therefore, has two directions of rotation. The electric motor drive can be triggered either by a vehicle-linked selector device or also by means of a remote control which is integrated, for example, on the key of the motor vehicle.

In one preferred embodiment of the device in accordance with the invention, in a sudden significant change, especially an increase in the rpm of the motor shaft, the electronic isolation means is activated. This design of the device in accordance with the invention, therefore, evaluates the dynamic characteristic of the pivoting body part and concludes therefrom possible activation of the electronic isolation means.

To determine the rpm of the motor shaft, the sensor means can comprise an rpm sensor which is located in the region of the motor shaft, such as, for example, a Hall sensor or also an optical rpm sensor, and/or a motor current evaluation means by which the rpm of the motor shaft can be deduced by evaluating the current/time behavior. The corresponding rpm sensors and/or current sensors are used in the region of the rear hatch system to detect the pivoting position of the rear hatch and/or in concert for an anti-pinching system and can then also be used for the device designed in accordance with the invention for detection of manual actuation of the pivoting body part, evaluation of the corresponding signals by an electronic control means taking place for electronic driving. The rpm sensor can be located either within the housing of the electrical motor drive or also in the region of the gearing for coupling the electric drive to the hatch.

In addition or alternatively, the sensor means can also comprise a switching device in the region of the actuation handle for the pivoting body part. The switching device is made, for example, as a mechanical switching device and especially as a switching device which operates when the actuating handle is actuated for the pivoting body part. It is also conceivable for the switching device to be an optical switching device or one which works with ultrasonic waves, and which recognizes action on the actuating handle.

In order to be able to carry out manual actuation essentially only against a force of, for example, gas springs which are used in the region of rear hatches, in one preferred embodiment of the device in accordance with the invention, the gearing is made as non-self-locking gearing. In this gearing which is formed, for example, as spur gearing or planetary gearing, only small friction forces occur so that this cannot be perceived or can only be barely perceived by the individual undertaking manual actuation.

The device in accordance with the invention can be switched in different ways in the rest position of the pivoting body part. For example, the isolating means is activated in the rest position of the pivoting body part so that, for example, with the rear hatch opened, there is no braking action by the electric motor drive and manual actuation of the rear hatch can take place without additional isolation of the drive.

However, it is also possible to design the device in accordance with the invention such that, in the rest position of the pivoting body part, the isolation means is activated and the electric motor short circuited. In this case, the electric motor drive acts as a regenerative brake especially when the rear hatch is opened, for manual actuation out of this rest position, the braking force of the electric motor drive must be overcome for a brief moment so that the sensor technology can recognize a significant change of the rpm. In this connection, it must be ensured that the control means measures a significant change of the rpm of manual actuation and not actuation of the electric motor drive and the resulting rotation of the motor shaft. This can be achieved, for example, by setting rpm boundary values since manual actuation is generally associated with faster pivoting motion of the pivoting body part than electric motor actuation.

Other advantages and advantageous embodiments of the subject matter in accordance with the invention can be taken from the following detailed description and accompanying drawings.

### BRIEF DESCRIPTION OF THE DRAWINGS

FIG. 1 is a simplified schematic view of the rear end a motor vehicle designed as a so-called minivan with a rear hatch and a drive device designed in accordance with the invention for the rear hatch; and

FIG. 2 is a circuit diagram of the drive device of the rear hatch.

### DETAILED DESCRIPTION OF THE INVENTION

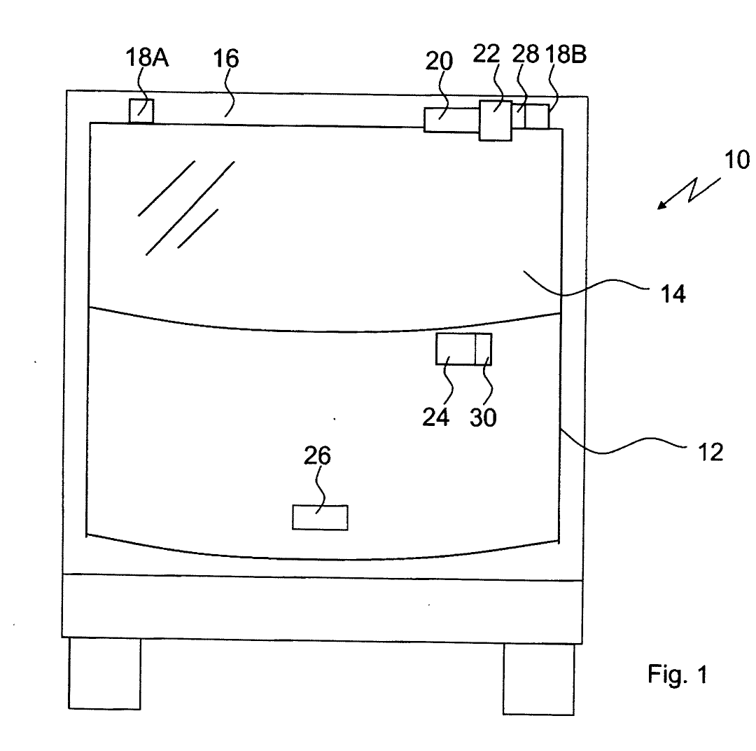

FIG. 1 shows a motor vehicle 10 which is provided with a rear opening 12 which can be closed by means of a rear hatch 14 which is pivotally fixed in the region of the rear roof edge 16 via hinges 18A, 18B.

For opening and closing, the rear hatch 14 is provided with an electric motor drive 20 which is fixed in the region of the rear roof edge 16. The electric motor drive 20 is provided with a motor shaft (not shown), and which acts on gearing 22, which is made as spur gearing, therefore is made as a non-self-locking gearing, and is connected to the rear hatch 14 in the region of the hinge 18B so that the rear hatch 14 is opened or closed with motor support when the drive 20 is activated.

Via control lines (not shown), the electric motor drive 20 is connected to a control means 24 which, depending on operating signals which are described below, dictates the actuating state of the electric motor drive 20.

For manual actuation, the rear hatch 14 is also provided with a handle 26 which interacts with a locking means for the rear hatch 14.

In the region of the hinge 18B, to detect the pivoting position of the rear hatch 14, there is an angle sensor 28 which is, likewise, connected to the control means 24.

A motor current evaluation means 30 which is assigned to the control means 24 detects the motor current which arises when the electric motor drive 20 is actuated and also when the rear hatch 14 is manually actuated and evaluates it with respect to its behavior over time. The respective rpm of the motor shaft of the drive 20 can be deduced from the motor current. When the rpm of the motor shaft changes significantly, which is generally the case for manual intervention into the pivoting motion for motorized actuation of the rear hatch 14, the control means 24 interrupts the current supply to the electric motor drive 20 which has two directions of rotation so that the motor shaft 20 is switched into the free-running state.

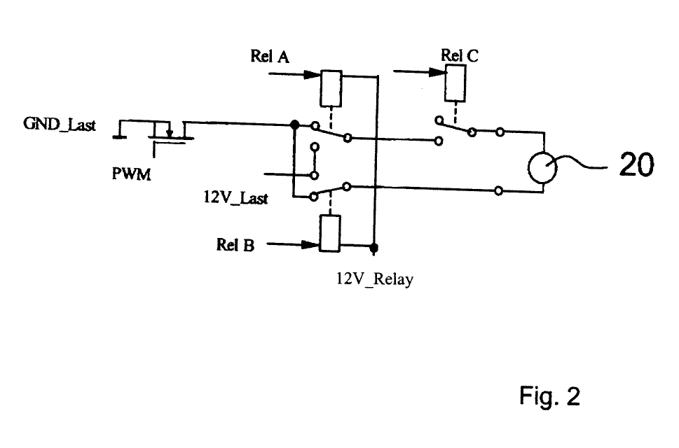

The operating states for an electric motor drive 20 are explained below using the circuit diagram shown in FIG. 2.

To open the rear hatch 14, the electric motor drive 20 is shifted into so-called clockwise rotation, for which relays Rel A and Rel C are supplied with current. To close the rear hatch 14, the electric motor drive 20 is shifted into so-called counterclockwise running, for which relays Rel B and Rel C are supplied with current.

If, at this point, the current evaluation means 30 of the control means 24, which constitutes a sensor means, detects that there is a significant increase in the rpm during opening or closing of the rear hatch 14, which can be initiated in proper operation by additional manual actuation of the rear hatch 14, i.e., by additional kick-starting of the pivoting motion of the rear hatch 14, a control process takes place by the control means 24 so that the relays Rel A, Rel B and Rel C are not supplied with current. Due to this operating position of relays Rel A, Rel B and Rel C which constitute the rest state, isolation of the electric motor drive 20 takes place so that the motor shaft is in the free running state and the drive 20 cannot apply any of the force which inhibits manual actuation to the rear hatch 14. The switching device 24 therefore also acts as an electronic isolation means.

If the rear hatch 14 is in the idle position, i.e., in its upper open position which can be recognized by means of an angle sensor 28 and motor current detection means 30 of the control means 24, the relay Rel C is supplied with current, relays Rel A and Rel B not being supplied with current. Then, the short-circuited electric motor drive 20 acts as a regenerative brake.

The electric motor drive 20 is triggered in this embodiment pulse-width modulated so that, in motorized actuation of the rear hatch 14, the rpm of the motor shaft can be dictated by the control means 24.

1-9. (canceled)

10. Device for opening and closing a pivoting body piece, comprising:
an electric motor drive which drives a motor shaft which drives the pivotable body piece via a gearing,
a sensor means for detecting manual operation of the pivoting body piece, and
an electronic isolation means for affecting operation of the electric motor drive, said electronic isolation means being activated in response to a signal from said sensor means.

11. Device as claimed in claim 10, wherein said pivoting body piece is a rear hatch of a motor vehicle.

12. Device as claimed in claim 11, wherein said sensor means is operable for detecting a sudden significant change in the rpm of the motor shaft for activation of the electronic isolation means.

13. Device as claimed in claim 11, wherein the sensor means comprises an rpm sensor which is located in proximity to the motor shaft.

14. Device as claimed in claim 11, wherein the sensor means comprises a motor current evaluation means.

15. Device as claimed in claim 11, wherein the sensor means comprises a switching device in an area of an actuating handle for the pivoting body part.

16. Device as claimed in claim 11, wherein the gearing is a non-self-locking gearing.

17. Device as claimed in claim 16, wherein the gearing is one of a spur gearing and a planetary gearing.

18. Device as claimed in claim 11, wherein the isolation means is activated in a rest position of the pivoting body part.

19. Device as claimed in claim 11, wherein the isolation means is deactivated and the electric motor drive is short circuited in a rest position of the pivoting body part.
